(19) United States
(12) Patent Application Publication
(10) Pub. No.: US 2026/0065019 A1
(43) Pub. Date: Mar. 5, 2026

(54) LEVERAGING GENERATIVE ARTIFICIAL INTELLIGENCE AGENTS TO FACILITATE USER-CENTRIC, GOAL-BASED EVALUATIONS OF APPLICATIONS

(71) Applicant: INTUIT INC., Mountain View, CA (US)

(72) Inventor: Manas Kumar MUKHERJEE, Mountain View, CA (US)

(21) Appl. No.: 18/821,766

(22) Filed: Aug. 30, 2024

(51) Int. Cl. G06N 3/045; G06N 3/0475

(52) U.S. Cl. CPC G06N 3/045; G06N 3/0475

(57) ABSTRACT

Aspects of the present disclosure relate to evaluating performance of a generative machine learning model. Embodiments include using a plurality of generative machine learning models to generate evaluation questions, wherein each of the generative machine learning models is configured to use a given persona for generating one or more of the evaluation questions. Embodiments further include providing the evaluation questions as input to a target application. Embodiments further include generating an indication of a level of performance of the target application based on evaluating an answer generated in response to a question of the evaluation questions.

### INTRODUCTION

Aspects of the present disclosure relate to techniques for automated evaluation of generative machine learning models using generative artificial intelligence agents. In particular, techniques described herein involve using multiple artificial intelligence agents with various personas to generate evaluation questions and evaluating the performance of a target application based on responses to the questions.

### BACKGROUND

A growing number of people, businesses, and organizations around the world use generative machine learning technologies to perform tasks. For example, generative machine learning models may be used to generate written responses to queries submitted by users in real time.

Outputs generated by machine learning models may contain errors. For example, a machine learning model may generate a response to a query that is inaccurate, irrelevant, or otherwise inappropriate. Detecting these errors can be extremely difficult and time-consuming. As an example, developers of a software application that uses generative machine learning technologies may manually submit queries such as questions to a model and evaluate the model based on the response generated by the model. However, queries created by a relatively small team of testers may rarely be representative of the queries submitted by the thousands of users of a software application (e.g., the users may come from a diverse range of backgrounds, have varying levels of writing proficiency, and have varying writing styles). A generative machine learning model may generate different responses to a query based on the characteristics of the queries submitted by different users. Because queries submitted during manual testing are often not representative of the queries submitted by the user base, manual testing procedures may fail to detect errors that occur during normal use of the software application. Also, while user feedback can be used to detect errors made by generative machine learning models, obtaining such feedback requires users to first encounter the errors themselves. Users who encounter errors may lose trust in the software application that made the errors.

Thus, there is a need in the art for improved techniques for evaluating the performance of generative machine learning models.

### BRIEF SUMMARY

Certain embodiments provide a method of evaluating performance of generative machine learning models. The method generally includes: using a plurality of generative machine learning models to generate evaluation questions, wherein each of the generative machine learning models is configured to use a given persona for generating one or more of the evaluation questions; providing the evaluation questions as input to a target application; and generating an indication of a level of performance of the target application based on evaluating an answer generated in response to a question of the evaluation questions.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to evaluating the performance of generative machine learning models.

FIG. 2 depicts an additional example of computing components related to evaluating the performance of generative machine learning models.

FIG. 3 depicts example operations related to evaluating the performance of generative machine learning models.

FIG. 4 depicts an example of a processing system for evaluating the performance of generative machine learning models.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically evaluating the performance of a generative machine learning model.

According to certain embodiments, a plurality of generative machine learning models may generate questions that are used for evaluating a target machine learning model. In some embodiments, other types of programs besides machine learning models may be evaluated. For example, any type of application that generates a text-based response to a text-based input may be evaluated using embodiments disclosed herein. Each of the plurality of generative machine learning models may be configured to use a given persona for generating the questions. For example, a persona may comprise a level of proficiency in a given language, a sentiment, and/or other characteristics that may be associated with users of a software application. The generative machine learning models may also generate answers to the questions, and the answers may be used to evaluate the target machine learning model or other target application (e.g., an answer generated by the target model or other target application may be compared to the generated answers). The questions and/or answers may be generated based on a specialized knowledge base such that the content of the questions and/or answers is accurate and any answers are relevant to the corresponding question.

In some embodiments, a plurality of generative machine learning models may be configured to generate evaluation questions using different personas. Users may select a persona for a model, default personas may be used, or personas may be selected based on personas of questions associated with a particular domain. For example, questions may be submitted by users of a domain such as a website or software application, and the generative machine learning models may generate questions based on the personas associated with the user-submitted questions (e.g., the generated questions may be based on sentiments, levels of ambiguity, and levels of language proficiency associated with user-provided questions). As another example, a user-submitted question may be retrieved, and variations of the user-submitted question with different personas may be generated. As used herein, the word “question” may also refer to commands (e.g., an instruction for a machine learning model to perform a task) in addition to interrogative queries. The word “answer”may refer to any response to a question.

Certain embodiments provide that the user-submitted questions from the particular domain are retrieved based on submitting an application programming interface (API) call to the particular domain. For example, the generative machine learning models may be configured to retrieve questions by submitting the API calls. In some embodiments, the API calls may be submitted based on an indication provided by a user of the model performance evaluation system. For example, the user may want to generate questions based on questions submitted to a particular website; the user may select this website and an API call may be submitted to retrieve questions from the website.

In some embodiments, the given persona comprises a level of proficiency in a given language. A question with a high level of proficiency may contain few or no grammatical and/or stylistic errors. A question with a low level of proficiency may contain several grammatical and/or stylistic errors. Thus, if a generative machine learning model is assigned a persona that has a low level of proficiency in a language, a question generated by the model may contain one or more grammatical errors.

Certain embodiments provide that proficiencies of generative machine learning models may be determined based on proficiency evaluation questions. For example, the level of proficiency of a generative machine learning model may be based on responses to proficiency evaluation questions (such as questions similar to questions used in the Test of English as a Foreign Language (TOEFL)). Assigning a low level of proficiency to a generative machine learning model may comprise prompting the model to generate questions as a person with a low TOEFL score (or a low reading/writing grade level, or a low score in another similar metric). Furthermore, the model may be evaluated using the TOEFL questions (e.g., prompted to provide an answer to the questions), and if the model's score for the questions does not match the assigned proficiency, the model may be retrained and/or reconfigured (e.g., provided with an additional prompt telling it to act as a person with an even lower level of proficiency).

According to some embodiments, the given persona comprises a level of ambiguity for questions. A level of ambiguity may involve a probability that a given question could be interpreted in more than one way. A highly ambiguous question may be a question that could be interpreted in several ways, whereas a question with a low level of ambiguity may have fewer probable interpretations. For example, the question “How will my tax return be affected if I just got married? ” may be highly ambiguous due to the phrase “just got. ” For example, “just got” could mean that the user was married before the tax year at issue, during the tax year at issue, or after the tax year at issue. Thus, there are at least three possible interpretations of the question that could each lead to different answer. By contrast, the question “How will my marriage on Feb. 1, 2024 affect my income tax liability for 2024?” has a lower level of ambiguity because it is clear when the marriage occurred relative to the tax year at issue. When the persona for a generative machine learning model includes a low level of ambiguity, the model may generate questions that are not ambiguous (or less ambiguous than questions generated by a model with a high level of ambiguity).

Some embodiments provide that the given persona comprises a sentiment for questions. A sentiment may comprise a level of aggressiveness (e.g., from calm to hostile/angry) a level of happiness (e.g., from sad to happy), and/or the like. For example, a generative machine learning model with a calm tone may generate the question “Please provide a list of recommended news articles. ” By contrast, a generative machine learning model with a more hostile tone may generate the question “Give me recommendations for a news article to read!”

In certain embodiments, a generative machine learning model may generate a correct answer to an evaluation question. The correct answer may be generated based on a specialized knowledge base. The knowledge base may comprise information that can be used to answer the questions. For example, the generated questions may be variations of an original set of questions with different personas; the knowledge base may contain correct answers to the original questions. To prevent skewing of evaluation results, the target machine learning model may not be given access to the specialized knowledge base. For instance, the knowledge base may not be included in training data for the target machine learning model.

In some embodiments, the correct answer is based on an answer provided by a user associated with a particular domain. For example, a user of a software application may submit an answer to a question that was submitted by another user. This answer may be retrieved, such as via an API call to the particular domain, and the retrieved answer may be used as the correct answer (or the generative machine learning model may generate an answer based on the retrieved answer).

According to some embodiments, the performance of the target machine learning model is evaluated based on a response that the target model generates to an evaluation question. For example, the response generated by the target model may be compared to a correct response (e.g., a response generated by the generative machine learning models). This comparison may comprise a text-based comparison involving n-grams (n-grams are generally groups of up to n consecutive words or characters, where n is a positive integer). For instance, n-grams of the target model response may be compared to n-grams of the correct response using a bilingual evaluation understudy (BLEU) algorithm. The comparison may comprise a semantic similarity comparison. For example, embedding representations may be created of the correct response and the target model response. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. The embedding representations may be compared (e.g., using Euclidean distance as a measure of similarity) in order to determine the level of semantic similarity between the responses. If the response generated by the target model differs from the correct response by more than a threshold amount, this may indicate that the target model has a low level of performance. An indication of the level of performance of the target model (e.g., a score based on the similarity of the target model's response to the correct response) may be provided to the user.

According to some embodiments, one or more tasks may be performed based on the indication. For instance, the target machine learning model may be retrained or otherwise reconfigured based on an indication of low performance. As an example, the indication may comprise a score (e.g., a score based on comparing an answer generated by the target model to the correct answer), and the score may be included in training data for a supervised learning process involving the target machine learning model. Supervised learning techniques generally involve providing training inputs to a machine learning model. The machine learning model processes the training inputs and outputs predictions based on the training inputs. The predictions are compared to the known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and/or the like. In some embodiments, validation and testing are also performed for a machine learning model, such as based on validation data and test data, as is known in the art.

A supervised learning process for the target machine learning model may involve a training data set that includes one or more answers generated by the target model in response to a question along with a score indicating the performance of the target model. One or more parameters of the target model may be adjusted until answers generated by the target model resemble answers associated with a high score more than answers associated with a low score.

Certain embodiments provide that the performance of the target machine learning model is evaluated based on comparing the response generated by the target model to the evaluation question. A text and/or semantic similarity comparison as described above may be used to determine whether the response addresses the question or correctly answers the question. For example, if the response differs semantically from the evaluation question by more than a threshold amount, it may be determined that the response is not relevant to the question.

Some embodiments provide that one or more follow-up questions may be generated and provided to the target machine learning model based on the response generated by the target machine learning model. For example, it may be determined (e.g., based on comparing a response to the correct response) that a response generated by the target machine learning model does not accurately or fully answer a question. Based on this determination, a follow-up question may be generated. For example, if a response does not provide all of the information necessary to answer a question, the follow-up question may relate to the information that was not provided. By generating questions and follow-up questions, the generative machine learning models may mimic interactions between real users and the target language model. Also, the evaluation of the target machine learning model may be based on the number of questions required to obtain a complete/correct answer to the question. For example, if ten follow-up questions are required, this may indicate a low level of performance for the target machine learning model, whereas the target model may have a high level of performance if only two follow-up questions are required.

In certain embodiments, generative machine learning models may be assigned different roles in evaluating the performance of a target machine learning model. For example, a first generative machine learning model may prepare a high-level plan for evaluating the target model. This may comprise determining sources from which to retrieve questions and/or answers (e.g., the plan may comprise retrieving the top ten most frequently asked questions from a domain). A second generative machine learning model may retrieve/generate the questions and/or answers such as by submitting an API call to a domain that contains the questions. A third generative machine learning model may interact with the target machine learning model by providing the questions to the target model. A fourth generative machine learning model may evaluate the target model's responses.

According to some embodiments, techniques disclosed herein may be used to perform automated A/B testing. In A/B testing, two or more variants of a software application (e.g., a language processing machine learning model or an application that uses such models or other response generation techniques) are deployed by the developers of the application to be used by users. The users may use each variant of the application, and the variant that performs the best (e.g., a variant that generates responses that are more correct/relevant) may be selected by the developers of the application. For example, the best-performing variant may be deployed for use by all users of the application, while other variants may be taken offline. Using embodiments disclosed herein, A/B testing can be performed without deploying variants of an application to users. For example, the characteristics of the various users of an application may be simulated by the generative machine learning models, and the variants may be evaluated based on their performance in response to inputs from the simulated users. A variant that performs the best (e.g., a variant that generates responses that are closest to a correct response) may be selected for deployment.

Embodiments of the present disclosure provide numerous technical and practical effects and benefits. For instance, using generative machine learning models with various personas to generate questions allows for accurately mimicking interactions between users and language processing machine learning models. Because these questions may accurately represent questions submitted by the user base of a machine learning model, problems associated with the machine learning model may be automatically identified that might otherwise go undetected (e.g., because the unique input questions submitted by users may lead to unique outputs and unique errors, and techniques described herein enable the automated generation of questions that are more like such unique questions). While existing techniques for detecting such errors rely on deploying a machine learning model and receiving user feedback in response to errors, techniques disclosed herein allow for accurately replicating such deployment without exposing real users to low-performing machine learning models, and preemptively identifying issues with machine learning models in an automated manner so that such issues can be addressed before model deployment. By enabling automated detection of machine learning model errors so that such errors can be addressed, techniques described herein improve the functioning of such machine learning models and/or enable intelligent selection of which machine learning model(s) to deploy.

### Example of Computing Components Related to Evaluating Generative Machine Learning Models

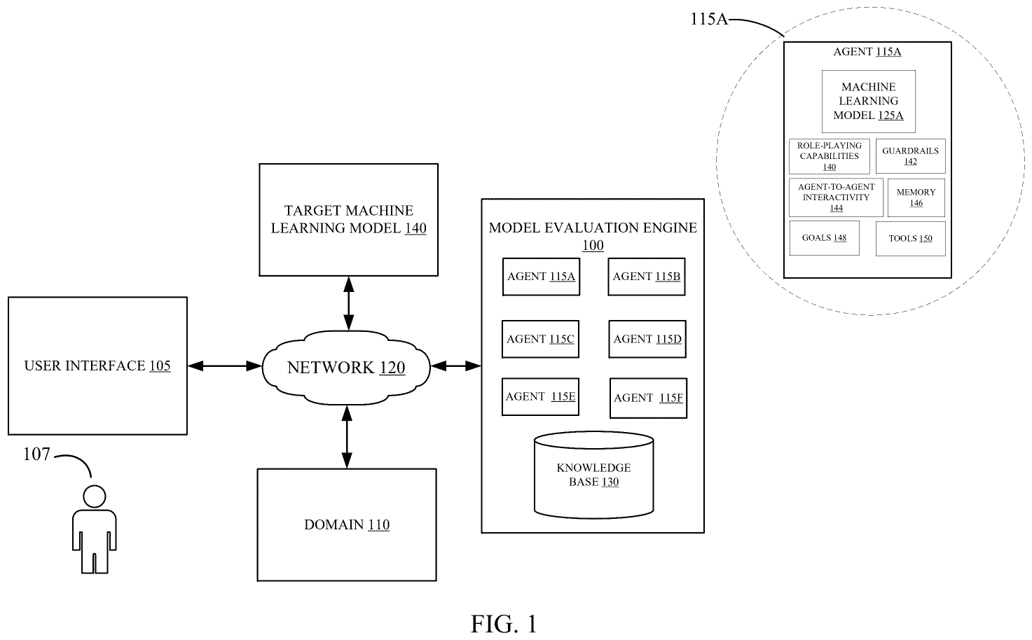

FIG. 1 depicts an example of computing components related to evaluating generative machine learning models.

A user 107 may interact with a computing system via a user interface 105. An application associated with the user interface 105 may interact with a target application, such as target machine learning model 140, a model evaluation engine 100, and/or a domain 110 over a network 120.

The target machine learning model 140 may be a generative machine learning model such as a large language model (LLM). The target machine learning model 140 may be trained and/or otherwise configured to generate natural language responses to questions submitted by users. In certain embodiments, a target application rather than a machine learning model may be evaluated. For example, the target application may be an application that uses one or more machine learning models (e.g., traditional natural language processing-based machine learning models, rules-based engines, or large language models) to generate text-based responses. In other embodiments, the application may be an application that does not use machine learning techniques. For example, the application may use a set of rules and/or natural language processing (NLP) techniques to generate a text-based response to a text-based input. Generally, any type of application that generates a text-based response to a text-based input may be evaluated using techniques described herein. Further embodiments provide that the performance of human users may be evaluated as well. For example, a response to an evaluation question written by a human may be evaluated.

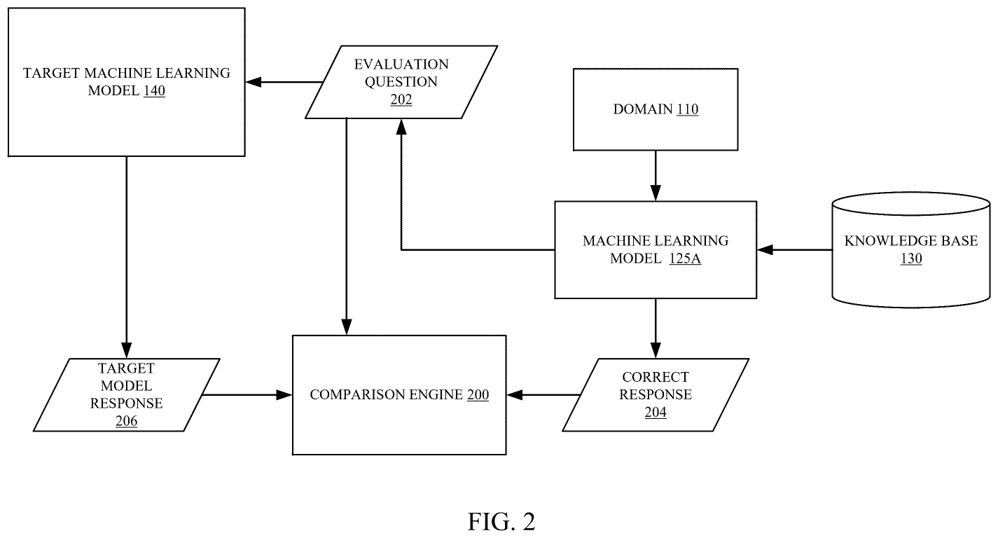

The model evaluation engine 100 may comprise multiple machine learning models 125 and is configured to evaluate the performance of target machine learning model 140. In some embodiments, the model evaluation engine 100 may use an application programming interface (API) call to invoke a plurality of machine learning models 125 hosted separately from the model evaluation engine 100. As discussed in further detail below with respect to FIG. 2, each machine learning model may be used by an agent 115. The agent may generate an evaluation question using a given persona, which may include a sentiment, a level of proficiency in a language, a level of ambiguity, and/or one or more other characteristics. The agent 115 may also generate answers to the evaluation questions. The evaluation questions and answers may be based on information stored in knowledge base 130. Although six agents 115 are shown here, more (or fewer) may be used. For example, thousands of users may be simulated by using thousands of agents (and/or machine learning models) with thousands of corresponding personas. Alternatively, a single agent or machine learning model may generate questions in multiple personas, such as based on being prompted to generate such questions in such personas.

As shown in FIG. 1, agent 115A comprises a machine learning model 125A. The agent 115A may use this machine learning model 125A to generate questions and answers as well as perform other tasks as discussed herein. In some embodiments, each agent 115 may use a corresponding machine learning model (e.g., agent 115B uses machine learning model 125B, agent 115C uses machine learning model 125C, and so on). In other embodiments, each agent may use a common machine learning model, or a machine learning model of a set of machine learning models.

The agent 115A further comprises role-playing capabilities 140. The role-playing capabilities 140 may comprise one or more prompts or other configurations that instruct the agent 115A to perform one or more particular roles, as discussed in further detail below (e.g., preparing a high-level plan and generating evaluation questions may each be roles). The agent 115A further comprises guardrails 142. Guardrails 142 are generally restraints on the activities that an agent 115 can perform. For example, a guardrail 142 may be a rule that prevents an agent 115 from generating a question about an irrelevant topic.

Agent 115A further comprises agent-to-agent interactivity 144. For example, the agent-to-agent interactivity 144 may comprise a configuration and/or a software component that enables agents 115 to interact with one another. For example, as discussed below, the agents 115 may coordinate to generate and execute a plan to evaluate the target machine learning model 140. Agent 115A further comprises a memory 146, which enables the agent 115A to remember aspects of interactions with target machine learning model 140 (e.g., the agent 115A may remember what questions have been asked and what answers were provided in response to the questions).

Agent 115A may further comprise goals 148. The goals 148 may relate to a goal associated with an evaluation task. For example, a goal 148 may be to determine whether the target machine learning model 140 is prone to hallucinations when asked about a certain topic. Based on this goal, the agent 115A may generate questions related to the topic. Agent 115A may further comprise tools 150. An example of a tool 150 that may be used by agent 115A is an API call to a domain such as a website.

The evaluation questions and answers may be based on information contained within domain 110. Domain 110 may correspond to an internet-accessible domain such as a website. The information within domain 110 may include user-submitted information, such as questions and answers to the questions (e.g., questions and answers in an online forum). Model evaluation engine 100 may be configured to retrieve information from domain 110, such as by submitting an API call to domain 110.

As described in further detail below with respect to FIG. 2, the evaluation questions may be provided to target machine learning model 140, and the responses generated by target machine learning model 140 based on the questions may be provided to model evaluation engine 100. Model evaluation engine 100 may then evaluate the performance of the target machine learning model 140 based on the generated response. For example, the evaluation may comprise comparing the response to a correct answer. The results of the evaluation may be provided to the user 107 via the user interface 105. For example, the user may be provided with an indication of the similarity of the response generated by the target machine learning model 140 to the correct answer or the relevance of the generated answer to the question at issue (e.g., which may be determined based on comparing the question to the generated answer). The target machine learning model 140 may be scored based on the comparison, and the score may be presented to the user 107. A low score may indicate that the target machine learning model should be improved (e.g., retrained, trained with a different training data set, and or the like). Follow-up questions may be generated based on the response, and an indication of how many follow-up questions were used to obtain a correct and/or complete response may be provided to the user 107 or used to determine a score.

In some embodiments, one or more of the agents 115A-F may be configured to generate and execute a plan for evaluating the target machine learning model 140 such that each agent 115A-F plays a particular role in developing or executing the plan. For example, agent 115A may prepare a high-level plan for evaluating the target machine learning model 140. This may comprise selecting domains such as domain 110 from which to retrieve information. Agent 115B may retrieve/generate the questions and/or answers such as by submitting an API call to domain 110 and/or by generating questions in one or more personas (e.g., based on retrieved questions). Agent 115C may interact with the target machine learning model by providing the retrieved/generated questions to the target machine learning model 140. Agent 115D may evaluate the target machine learning model's responses. In other embodiments, aspects of the functionality described with respect to agents 115A-F may be performed by one or more other components (e.g., that are not machine learning models). For example, in some embodiments, data is retrieved (e.g., from domain 110) by a software component that is not an agent, and is used to provide input to one or more agents for use in generating questions.

It is noted that techniques described herein with respect to examples involving testing a target machine learning model may also be used to test other types of target applications, such as target applications that generate text responses to text inputs with or without the use of machine learning models.

FIG. 2 depicts an additional example of computing components related to evaluating generative machine learning models.

Machine learning model 125A may comprise a generative machine learning model, such as an LLM. Machine learning model 125A may be configured to generate an evaluation question 202 and a correct response 204 to the evaluation question 202. Machine learning model 125A may generate evaluation questions 202 and correct responses 204 based on information found in domain 110 and/or knowledge base 130. As discussed above with respect to FIG. 1, domain 110 may comprise a website or another type of internet accessible resource. Information within domain 110 may include questions submitted by users of the website and answers to those questions. Machine learning model 125A may be configured to access information within domain 110 by submitting an API call to domain 110, or may be provided with such information as input data by a separate component that retrieves such information. Machine learning model 125A may then generate an evaluation question 202 based on the information. For example, the evaluation question 202 may be a question from domain 110, a question that is based on information from domain 110, or a question that is similar to a question from domain 110 but has a different persona (e.g., a different sentiment, language proficiency level, and/or level of ambiguity). Similarly, the correct response 204 may be a response from domain 110 (e.g., a response submitted by another user) or a response that is based on information from domain 110 or knowledge base 130.

Knowledge based 130 may comprise a database that includes specialized knowledge regarding the subject matter of the evaluation questions 202. For example, the knowledge may comprise information provided by experts that operate a model evaluation system or a user of the model evaluation system. This information may include correct answers to questions, information that may be used to generate a correct answer to a question, and/or the like. The information within knowledge base 130 may not be provided to target machine learning model 140 to prevent skewing the results of evaluation. For example, if provided with the information within knowledge base 130, target machine learning model 140 may be able to generate correct answers to the evaluation questions 202 even if the target machine learning model 140 has deficiencies that would otherwise cause errors.

Machine learning model 125A may generate the evaluation questions 202 using a given persona. The given persona may comprise a sentiment (e.g., aggressive or calm), a level of language proficiency (e.g., high grade level or low grade level), a level of ambiguity (e.g., ambiguous or clear), and/or the like. The given personas may be determined based on personas associated with questions found in domain 110, or the personas may be customized by users. For example, a user of a model evaluation system may specify personas for the machine learning models 125 of the model evaluation system (e.g., by selecting values for parameters such as ambiguity, proficiency, and sentiment via a user interface). In some embodiments, a prompt is provided to machine learning model 125A instructing machine learning model 125A to generate an evaluation question 202 in a given persona, the prompt specifying values for parameters such as ambiguity, proficiency, and sentiment in order to define the given persona, such as including information (e.g., a question, such as a user-provided question) from domain 110 and/or knowledge base 130 as context with the prompt that is input to machine learning model 125A. In such a case, the information on which the generated question is based may be associated with a known answer (e.g., correct response 204, which may have been previously provided by or confirmed by a user) or information on which an answer may be based (e.g., machine learning model 125A may also be prompted to generate an answer, such as correct response 204, to the generated question, such as based on such information).

A given evaluation question 202 may be provided to the target machine learning model 140, which may generate the target model response 206 based on the given evaluation question 202. The target model response 206 may be provided to comparison engine 200, which may compare the target model response 206 to the correct response 204. The responses may be compared using textual similarity algorithms and/or semantic similarity algorithms. For example, comparison engine 200 may comprise an embedding model such as a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating vector representations of entities (such as embedding representations) are possible. The embedding representations of the responses may be compared, such as by using a machine learning model that is trained to compare embeddings and/or based on Euclidean distance. A low level of similarity may indicate that the target model response 206 is not correct and/or not relevant. As another example, comparison engine may generate n-gram representations of the responses and compare the n-grams. The n-grams may be compared using an algorithm such as bilingual evaluation understudy (BLEU). As with the embeddings, a low level of similarity may indicate that the target model response 206 is not correct and/or not relevant. Other techniques for comparing the semantic and textual similarity of responses as known in the art may be used. In some embodiments comparison engine 200 may also compare the target model response 206 to the evaluation question 202, such as using semantic similarity (e.g., by comparing embedding representations of target model response 206 and evaluation question 202 and/or n-grams of target model response 206 and evaluation question 202). A low level of semantic similarity (e.g., a similarity below a threshold) may indicate that the target model response 206 is not relevant to the evaluation question 202.

### Example Operations Related to Evaluating Generative Machine Learning Models

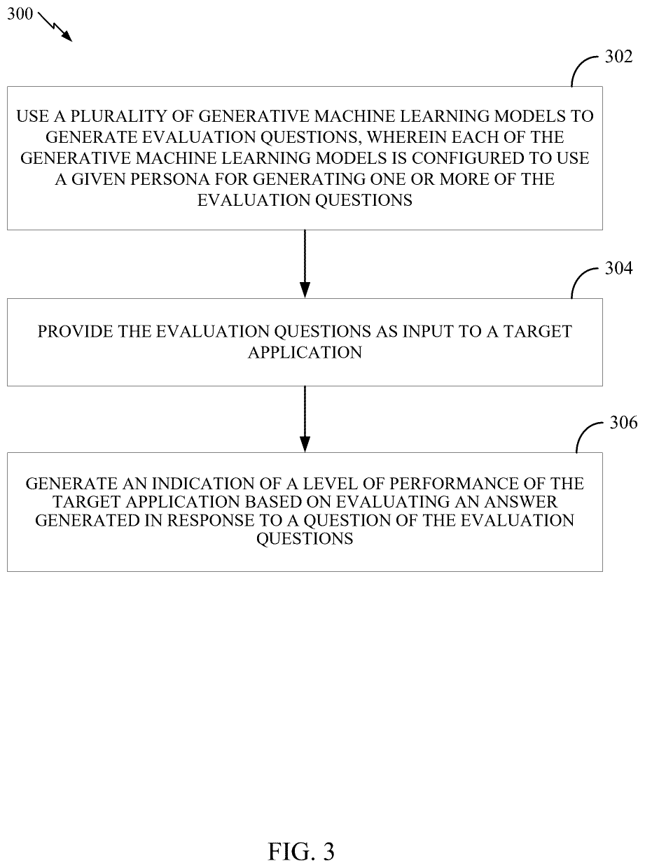

FIG. 3 depicts example operations 300 related to evaluating generative machine learning models. For example, operations 300 may be performed by one or more of the components described with respect to FIG. 1 or FIG. 2.

Operations 300 begin at step 302 with using a plurality of generative machine learning models to generate evaluation questions, wherein each of the generative machine learning models is configured to use a given persona for generating one or more of the evaluation questions. In some embodiments, the given persona comprises a level of proficiency in a given language. Certain embodiments provide that the given persona comprises a sentiment for a question. According to some embodiments, the given persona comprises a level of ambiguity for a question. In certain embodiments, the evaluation questions are based on questions submitted by users associated with a particular domain. Some embodiments provide that a correct answer to a question of the evaluation questions is based on an answer submitted by a user associated with the particular domain. According to certain embodiments, using the plurality of generative machine learning models to generate the evaluation questions comprises submitting an application programming interface (API) call to a particular domain and generating the evaluation questions based on information retrieved via the API call.

Operations 300 continue at step 304 with providing the evaluation questions as input to a target application.

Operations 300 continue at step 306 with generating an indication of a level of performance of the target application based on evaluating an answer generated in response to a question of the evaluation questions. According to some embodiments, the plurality of generative machine learning models are used to generate one or more follow-up evaluation questions based on the answer generated by the target application.

Some embodiments provide that a generative machine learning model is used to generate a correct answer to an evaluation question. In certain embodiments, the evaluating of the target application is based on comparing the answer generated by the target application to the correct answer. In some embodiments, the target application is a target generative machine learning model. In other embodiments, the target application utilizes a generative machine learning model to generate the answer. In still other embodiments, the target application does not utilize a generative machine learning model to generate the answer, such as generating the answer based on rules and/or natural language processing (NLP) techniques.

### Example of a Processing System for Evaluating Generative Machine Learning Models

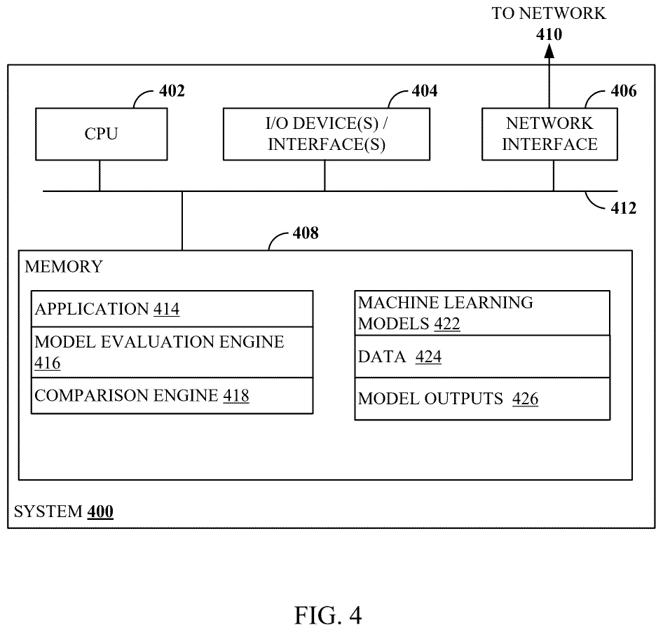

FIG. 4 illustrates an example system 400 with which embodiments of the present disclosure may be implemented. For example, system 400 may be configured to perform operations 300 of FIG. 3 and/or to implement one or more components as in FIG. 1 or FIG. 2.

System 400 includes a central processing unit (CPU) 402, one or more I/O device interfaces that may allow for the connection of various I/O devices 404 (e.g., keyboards, displays, mouse devices, pen input, etc.) to the system 400, network interface 406, a memory 408, and an interconnect 412. It is contemplated that one or more components of system 400 may be located remotely and accessed via a network 410. It is further contemplated that one or more components of system 400 may comprise physical components or virtualized components.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408. CPU 402 is included to be representative of a single CPU, multiple CPUs, a single CPU having multiple processing cores, and other arrangements.

Additionally, the memory 408 is included to be representative of a random access memory or the like. In some embodiments, memory 408 may comprise a disk drive, solid state drive, or a collection of storage devices distributed across multiple storage systems. Although shown as a single unit, the memory 408 may be a combination of fixed and/or removable storage devices, such as fixed disc drives, removable memory cards or optical storage, network attached storage (NAS), or a storage area-network (SAN).

As shown, memory 408 includes application 414, model evaluation engine 416, and comparison engine 418. Application 414 may be representative of a software application associated with user interface 105 of FIG. 1. Model evaluation engine 416 may be representative of model evaluation engine 100 of FIG. 1. Comparison engine 418 may be representative of comparison engine 200 of FIG. 2.

Memory 408 further comprises machine learning models 422, which may correspond to machine learning models 125A of FIG. 1. Memory 408 further comprises data 424, which may correspond to information stored in domain 110 or knowledge base 130 of FIG. 1 and FIG. 2. Memory 408 further comprises model outputs 426, which may include evaluation question 202, correct response 204, and target model response 206 of FIG. 2.

It is noted that in some embodiments, system 400 may interact with one or more external components, such as via network 410, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for. ” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of evaluating performance of a generative machine learning model, comprising:
using a plurality of generative machine learning models to generate evaluation questions, wherein each of the generative machine learning models is configured to use a given persona for generating one or more of the evaluation questions;
providing the evaluation questions as input to a target application; and
generating an indication of a level of performance of the target application based on evaluating an answer generated in response to a question of the evaluation questions.

2. The method of claim 1, wherein the given persona comprises a level of proficiency in a given language.

3. The method of claim 1, wherein the given persona comprises a sentiment for a question.

4. The method of claim 1, wherein the given persona comprises a level of ambiguity for a question.

5. The method of claim 1, further comprising using one or more of the plurality of generative machine learning models to generate a correct answer to an evaluation question.

6. The method of claim 5, wherein the evaluating is based on comparing the answer generated by the target application to the correct answer.

7. The method of claim 1, wherein the evaluation questions are based on questions submitted by users associated with a particular domain.

8. The method of claim 7, wherein a correct answer to a question of the evaluation questions is based on an answer submitted by a user associated with the particular domain.

9. The method of claim 1, further comprising using the plurality of generative machine learning models to generate one or more follow-up evaluation questions based on the answer generated by the target application.

10. The method of claim 1, wherein using the plurality of generative machine learning models to generate the evaluation questions comprises submitting an application programming interface (API) call to a particular domain and generating the evaluation questions based on information retrieved via the API call.

11. A system for evaluating performance of a generative machine learning model, comprising:
one or more processors; and
a memory comprising instructions that, when executed by the one or more processors, cause the system to:
use a plurality of generative machine learning models to generate evaluation questions, wherein each of the generative machine learning models is configured to use a given persona for generating one or more of the evaluation questions;
provide the evaluation questions as input to a target application; and
generate an indication of a level of performance of the target application based on evaluating an answer generated in response to a question of the evaluation questions.

12. The system of claim 11, wherein the given persona comprises a level of proficiency in a given language.

13. The system of claim 11, wherein the given persona comprises a sentiment for a question.

14. The system of claim 11, wherein the given persona comprises a level of ambiguity for a question.

15. The system of claim 11, wherein the instructions further cause the system to use one or more of the plurality of generative machine learning models to generate a correct answer to an evaluation question.

16. The system of claim 15, wherein the evaluating is based on comparing the answer generated by the target application to the correct answer.

17. The system of claim 11, wherein the evaluation questions are based on questions submitted by users associated with a particular domain.

18. The system of claim 17, wherein a correct answer to a question of the evaluation questions is based on an answer submitted by a user associated with the particular domain.

19. The system of claim 11, wherein the instructions further cause the system to use the plurality of generative machine learning models to generate one or more follow-up evaluation questions based on the answer generated by the target application.

20. The system of claim 11, wherein using the plurality of generative machine learning models to generate the evaluation questions comprises submitting an application programming interface (API) call to a particular domain and generating the evaluation questions based on information retrieved via the API call.
